(19) United States
(12) Patent Application Publication
(10) Pub. No.: US 2025/0012026 A1
(43) Pub. Date: Jan. 9, 2025

(54) SOLID ANIMAL WASTE DISINTEGRATION

(71) Applicant: ISLAND PROJECT LLC, Ann Arbor, MI (US)

(72) Inventors: Zhihua Fang, Ann Arbor, MI (US); Jeffrey L. Clark, Commerce, MI (US); Dennis Nash, West Bloomfield, MI (US); Robert S. Simms, Commerce, MI (US)

(73) Assignee: ISLAND PROJECT LLC, Ann Arbor, MI (US)

(21) Appl. No.: 18/762,912

(22) Filed: Jul. 3, 2024

Related U.S. Application Data
(60) Provisional application No. 63/524,699, filed on Jul. 3, 2023.

(51) Int. Cl. E01H 1/00; E01H 1/12; G05D 1/249; G05D 1/648; G05D 109/10

(52) U.S. Cl. CPC E01H 1/008; E01H 1/1213; G05D 1/249; G05D 1/648; G05D 2109/10

(57) ABSTRACT

A hand-held device, a roamer device, a walk-behind device, and a towed device that facilitates the disintegration of solid animal waste using high-pressure streams of fluid. The disintegration apparatus includes a liquid reservoir, high-pressure pump, one or more nozzles, and a nozzle cone. The nozzle cone is configured to expand to cover the animal waste, after which the high-pressure pump expels fluid from the reservoir through the nozzles to disintegrate the waste.

### CROSS-REFERENCE TO RELATED APPLICATION

This application claims priority to U.S. Provisional Patent Application No. 63/524,699 filed on Jul. 3, 2023, entitled “SOLID DOG WASTE DISINTEGRATOR AND SOLID DOG WASTE DISINTEGRATOR ROAMER” the entire disclosure of which is incorporated herein by reference.

### TECHNICAL FIELD

The present specification generally relates to animal waste destruction, and, more specifically, to portable and autonomous liquid-based disintegration of solid animal waste.

### BACKGROUND

There have been a wide range of apparatuses and methods to gather and dispose of animal feces, and they are well documented in prior art of various devices and methods. There are scoops, bags, gloves, and various other contraptions to achieve the task of capturing and eliminating the animal feces.

Animal feces disposal is a task attended to by dog owners at home or when walking a dog. At home, the animal feces are scooped up by using various devices and then disposed of either in a bag or a container. When a dog is on a walk away from home, a dog owner usually carries a bag or a scoop to pick up the animal feces to be disposed of properly. Even with such conveniences as plastic bags, the task of collecting waste is repulsive, messy, and difficult to many.

In terms of animal feces disposal, dog owners usually put the animal feces in a bag and put it in the trash bin to be collected by the trash collector truck. A new development in some municipalities seems to indicate some cities are asking residents not to put dog solid waste in the trash can. This then creates a difficult problem for dog owners, as they then are forced to find new ways to dispose of the animal feces.

Therefore, a need exists for disposal of solid animal waste that overcomes the environmental issues and inconveniences associated with current waste disposal systems and methods.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a perspective view of a hand-held solid animal waste disintegration apparatus according to one or more aspects shown and described herein;

FIG. 2 is cross-sectional view of a hand-held solid animal waste disintegration apparatus of FIG. 1 according to one or more aspects shown and described herein;

FIG. 3A depicts a view of the nozzle cone of FIGS. 1-2 in the closed/stored position according to one or more aspects shown and described herein;

FIG. 3B depicts a view of the nozzle cone of FIGS. 1-2 in the open/fanned position according to one or more aspects shown and described herein;

FIG. 4 depicts a perspective view of a hand-held solid animal waste disintegration apparatus according to one or more aspects shown and described herein;

FIGS. 5A-5D depict various views of the fan blades used by the nozzle cone of the hand-held solid animal waste disintegration apparatus of FIGS. 1-2 and 4 according to one or more aspects shown and described herein;

FIG. 6 is a view of an array of one or more nozzles of the hand-held solid animal waste disintegration apparatus of FIGS. 1-2 and 4 according to one or more aspects shown and described herein;

FIG. 7 is a view of the array of one or more nozzles of the hand-held solid animal waste disintegration apparatus of FIGS. 1-2 and 4 according to one or more aspects shown and described herein;

FIG. 8 depicts various sized nozzles of the hand-held solid animal waste disintegration apparatus according to one or more aspects shown and described herein;

FIG. 9 depicts a control panel of the hand-held solid animal waste disintegration apparatus according to one or more aspects shown and described herein;

FIG. 10 is an exploded view of a solid animal waste disintegration roamer according to one or more aspects shown and described herein;

FIG. 11 is a bottom view of the solid animal waste disintegration roamer according to one or more aspects shown and described herein;

FIG. 12A is a side view of the solid animal waste disintegration roamer according to one or more aspects shown and described herein;

FIG. 12B is a front view of the solid animal waste disintegration roamer according to one or more aspects shown and described herein;

FIG. 13 is an isometric view of the solid animal waste disintegration roamer according to one or more aspects shown and described herein;

FIG. 14A is a view of the solid animal waste disintegration roamer with top cover removed according to one or more aspects shown and described herein;

FIG. 14B is a view of the solid animal waste disintegration roamer according to one or more aspects shown and described herein;

FIG. 15 is a view of a charging pad for use by the solid animal waste disintegration roamer according to one or more aspects shown and described herein;

FIG. 16 is a top view the charging pad of FIG. 15 for use by the solid animal waste disintegration roamer according to one or more aspects shown and described herein;

FIG. 17 is an example block diagram of solid animal waste disintegration roamer components according to one or more aspects shown and described herein;

FIGS. 18A-18F are views of a tractor-pulled solid animal waste disintegration roamer according to one or more aspects shown and described herein;

FIGS. 19A-19D are views of a manual solid animal waste disintegration according to one or more aspects shown and described herein;

FIGS. 20A-20B are additional views of the manual solid animal waste disintegration according to one or more aspects shown and described herein; and

FIG. 21 depicts a controller of the solid animal waste disintegration roamer according to one or more aspects shown and described herein.

### DETAILED DESCRIPTION

The present disclosure relates to systems for disintegrating solid animal waste, e.g., feces, vomit, etc., using a stream of high-pressure liquid, e.g., water, water-based mixture, or the like. In some aspects contemplated herein, a portable wand with integrated liquid supply/reservoir, motor/pump to generate pressure, power source and one or more nozzles produce a high-pressure stream of the liquid through the one or more nozzles to disintegrate and destroy solid animal waste.

In accordance with some aspects, high-pressure is generated by a pump mechanism driven by a power source (e.g., a battery) to produce a high-pressure liquid stream through a nozzle to generate such strong liquid streams capable of disintegrating solid animal waste in a short period of time. In varying aspects disclosed herein, the aforementioned high-pressure may be generated by, for example and without limitation, a linear intensifier pump, a high-pressure water jet pump, a hyper-jet ultrahigh-pressure pump, a hydraulic pressure intensifier, or the like. The extreme high-pressure liquid streams disintegrate animal waste in such a manner that negates the need for picking up the waste for disposal.

As noted above, disposing of animal solid waste, such as from a dog, cat, etc., has known and obvious disadvantages in the sense that the prior art apparatus and methods are clumsy, unsanitary, ineffective, inefficient, and harmful to the environment as they often rely on the ultimate method of disposing fecal matter in the form of municipal waste collection service, which is not optimized for this specific purpose. Some aspects set forth herein provide new methods, apparatuses, and constructions for animal solid waste, e.g., feces, vomit, etc., disposal and disintegration that is portable, easy to use, environmentally friendly, cost efficient, effective, and functional.

Furthermore, some aspects presented herein assist animal owners to avoid municipal new trends to forbid pet owners from placing solid animal waste in trash bins. Aspects disclosed herein assist pet owners in resolving the animal solid waste problem on site, without the need to transport the waste, wrap the waste, or dispose of the waste anywhere else.

Accordingly, some aspects disclosed herein include a solid animal waste disintegration apparatus and method providing a user-friendly and eco-friendly task to dispose of animal feces, which is convenient, efficient, effective, and friendly to the environment.

Accordingly, some aspects disclosed herein include a solid animal waste disintegration device and method that eliminates the need of a human to touch directly animal feces. Further, provided herein are devices and methods to overcome the problem of having to dispose of animal feces separately, like in a plastic bag, as the disintegration returns the animal feces to the ground without a trace. It provides the convenience for dog owners and dog caretakers. With the roamer embodiment disclosed herein, the device is capable of taking care of the animal feces in the yard such that the dog owners need not collect and dispose of the waste any longer. Accordingly, the apparatuses, devices, and methods provided herein eliminates the use of plastic bags, improves the environment, and serves to fertilize the ground for grass to grow or to clean up the grounds for a more pleasant environment.

It should be appreciated that while the various embodiments and aspects described herein relate particularly to animal waste disintegration systems, the present disclosure is not limited to such. That is, the various components, systems, and methods described herein can be implemented in other manners, such as other motor driven devices or systems.

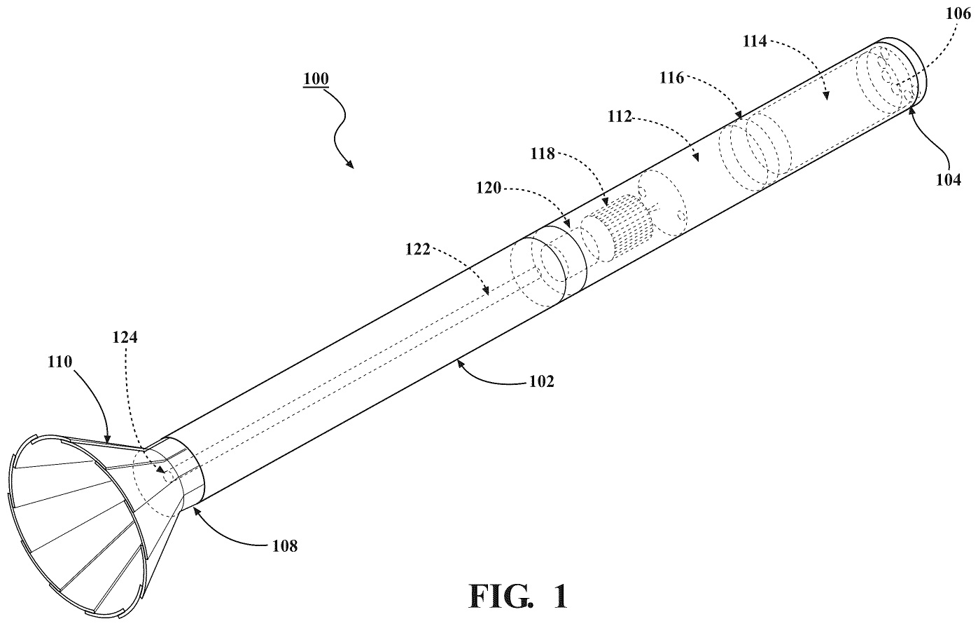

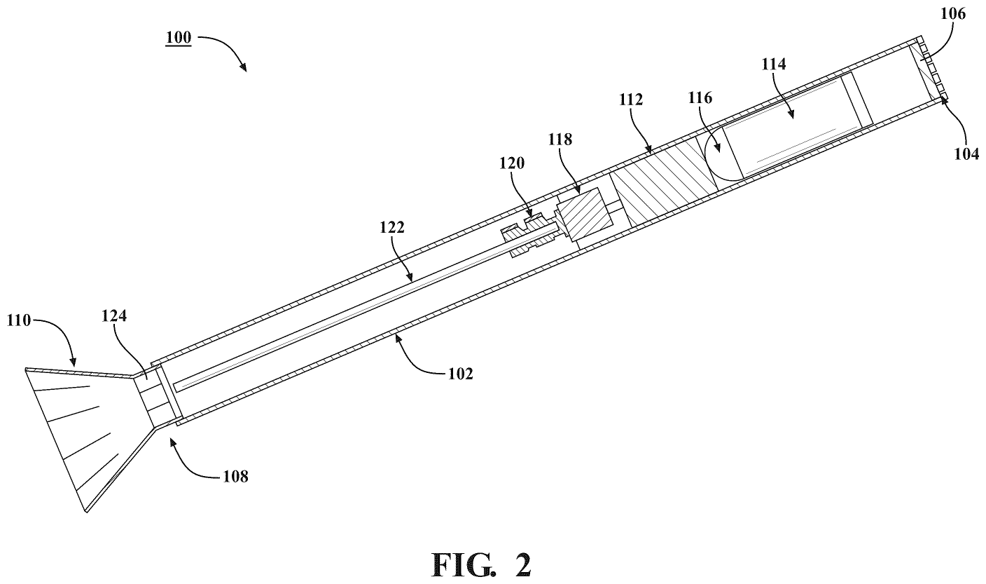

Turning now to FIGS. 1 and 2, there are shown, respectively, perspective and cross-sectional views of a hand-held solid animal waste disintegration apparatus 100 in accordance with some aspects of the subject disclosure. As shown in FIG. 1, the hand-held solid animal waste disintegration apparatus 100 includes a substantially cylindrical body 102 having a first end 104 including a control panel 106 having one or more display components associated therewith, and a second, opposing end 108 to which a nozzle cone 110 is removably attached.

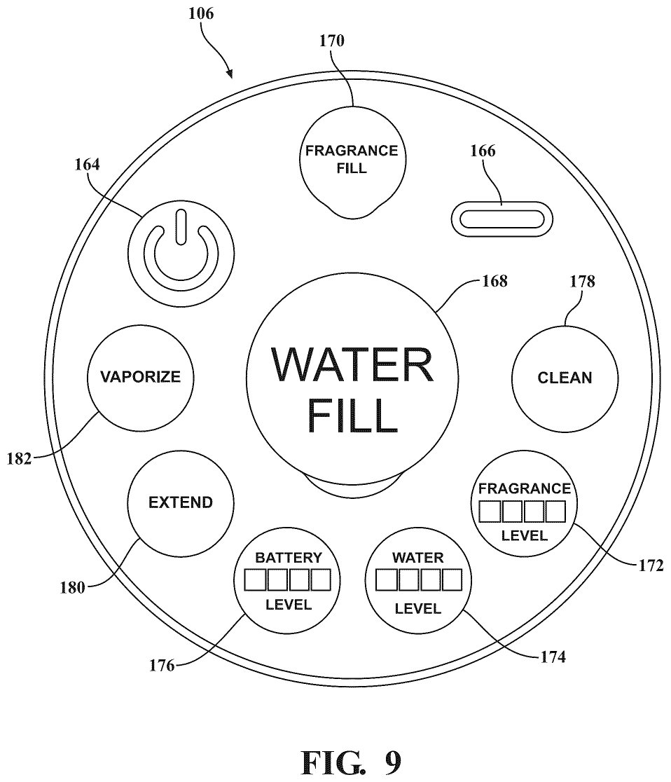

The one or more display components of the control panel 106 may comprise, for example and without limitation, power level, liquid level, fragrance level, on/off switch, cleaning status, or the like. A more detailed view of the various display components of the control panel 106 is shown in FIG. 9, discussed in greater detail below. In some aspects, the body 102 houses one or more internal components associated with the disintegration of solid animal waste. As shown in the example of FIG. 1, the body 102 may include, for example and without limitation, a power supply (e.g., battery, fuel cell, etc.) 112, liquid reservoir 114, fragrance reservoir 116, motor 118, pump 120, extended tube 122, and nozzle 124. It will be appreciated that the positioning and relative location of the various components 112-124 may be dependent upon certain design considerations and the illustration in FIG. 1 is intended as a non-limiting example implementation of the hand-held solid animal waste disintegration apparatus 100.

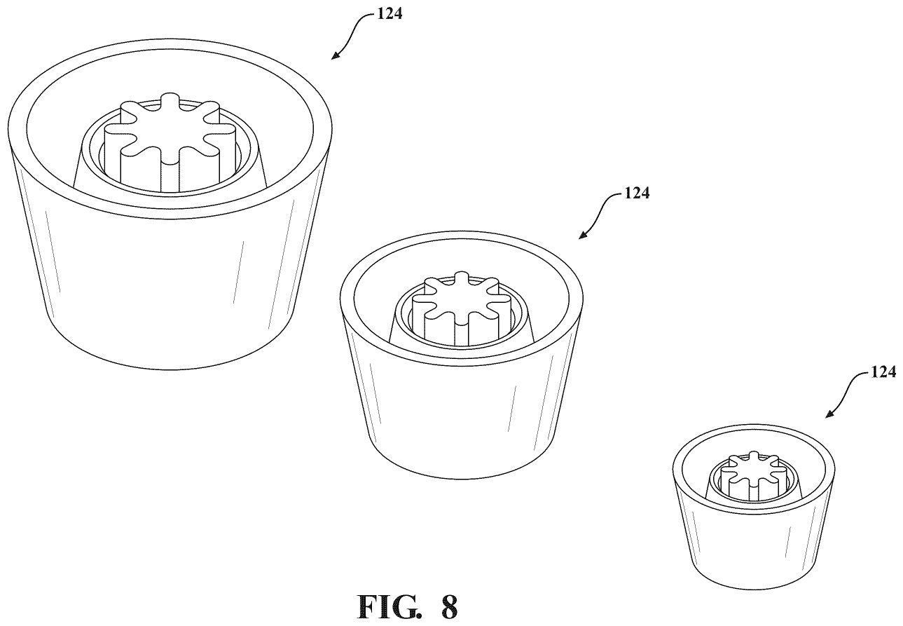

As illustrated in FIG. 1, the extended tube 122 is positioned within the body 102 and fluidly coupled to the pump 120 to enable pressurized liquid, e.g., water, to flow through tube 122 and out the nozzle 124. In some aspects, one or more tubes 122 may be utilized by the hand-held solid animal waste disintegration apparatus 100 in conjunction with or coupled to one or more nozzles. FIGS. 6-8, discussed in greater detail below, provide an illustration of a multiple nozzle 124 configuration in accordance with some aspects contemplated herein.

In accordance with some aspects disclosed herein, the pump 120 may be implemented as, for example and without limitation, a linear intensifier pump, or a high-pressure water jet pump, a hyper-jet ultrahigh-pressure pump, a hydraulic pressure intensifier, or the like. The pump 120 may be configured to provide varying levels of pressure, from minimal pressure (e.g., spraying fragrance) to extremely high-pressure (e.g., disintegration pressure). In some aspects, the pump 120 is a miniaturized version of one of the aforementioned implementations. The pump 120 may be configured to produce a spray of liquid with a fluid pressure at the nozzle 124 of about 800 to 1500 PSI, and in some implementations, a fluid pressure of about 1000 PSI. In producing such pressures, the pump 120 may be configured to have a flow rate in the range of about 0.05 to 0.15 gallons per minute (GPM), and in some implementations, have a flow rate greater than or equal to 0.1 GPM. In such aspects, the pump 120 and/or motor 118 may be supplied with power via a rechargeable or disposable power supply 112, including, for example and without limitation, a lithium-ion battery, nickel-cadmium battery, alkaline battery, fuel cell, or other suitable power storage or generation device, as will be appreciated. As shown in FIGS. 1 and 2, the power supply 112 supplies power to the motor 118 and/or pump 120, which operates to generate a high-pressure stream of fluid, e.g., water, from the liquid reservoir 114 through the tube 122 to the one or more nozzles 124.

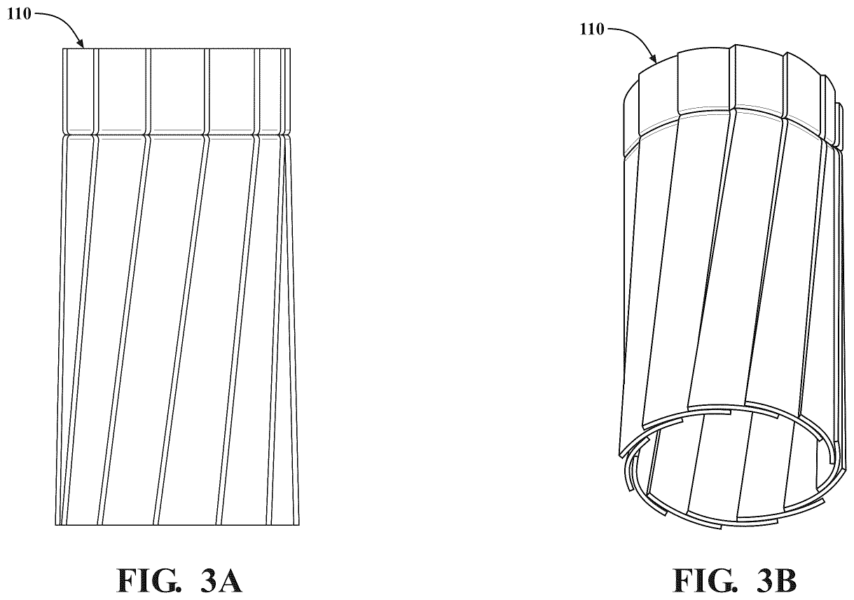

The hand-held solid animal waste disintegration apparatus 100 shown in FIG. 1 includes a nozzle cone 110 removably attached to the second, opposing end 108 of the body 102. In the illustration of FIG. 1, the nozzle cone 110 is depicted in an extended position, however, as shown in FIGS. 3A and 3B, the nozzle cone 110 may be retracted around the nozzle 124, retracted into the body 102, or a combination thereof. FIG. 3A provides an illustrative view of the nozzle cone 110 in an extended and fanned out position to cover any animal waste to facilitate safe operation where high-pressure liquid (e.g., water) jet(s) will be output through the one or more nozzles 124 via the motor 118/pump 120 through the extended tube 122 to disintegrate the animal waste. FIG. 3B provides an illustrative view of the nozzle cone 110 in a retracted/folded orientation, wherein the nozzle cone 110 may be retracted within the body 102 of the hand-held solid animal waste disintegration apparatus 100 in accordance with some aspects.

In other aspects, the nozzle cone 110 is disposable and/or replaceable. For example, the nozzle cone 110 may be a single or multiple use cone 110. In other aspects, a cleaning operation may be performed via nozzle 124 to clean any debris, e.g., disintegrated waste material, from the interior of the nozzle cone 110. In such a cleaning operation, various aspects contemplated herein may provide for one or more nozzles 124 to articulate, rotate, or otherwise move to enable liquid to contact the interior of the nozzle cone 110, thereby cleaning the nozzle cone 110 of any extraneous waste located therein.

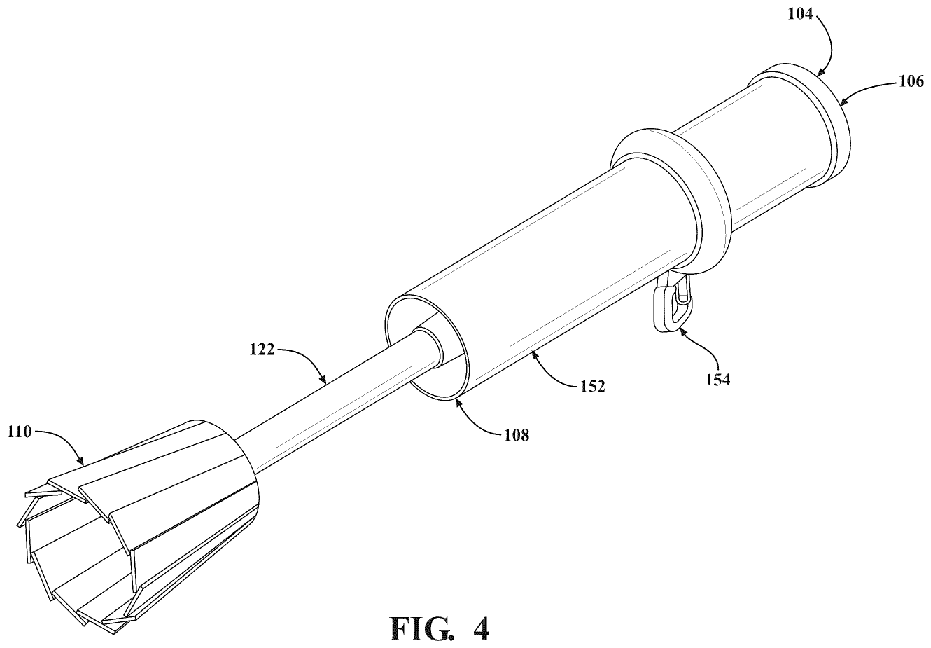

Turning now to FIG. 4, there is provided an illustrative view of an alternative body 152 for the hand-held solid animal waste disintegration apparatus 150 in accordance with another aspect of the subject disclosure. As shown in FIG. 4, body 152 of the hand-held solid animal waste disintegration apparatus 150 is collapsible, wherein the extended tube 122 and nozzle cone 110 are capable of retraction into the body 152. In addition, the body 152 of FIG. 4 includes a leash attachment component 154, configured to allow for the removable coupling of a leash (not shown) to the hand-held solid animal waste apparatus 150, removable coupling the hand-held solid animal waste apparatus 150 to belt or belt-loop of a user, removable coupling the hand-held solid animal waste apparatus 150 to a pet harness, collapsible water dish, or other animal-care devices. Accordingly, the aspects illustrated in FIG. 4 enable the leash and the hand-held solid animal waste apparatus 150 to form a single hand-held unit for easy carrying.

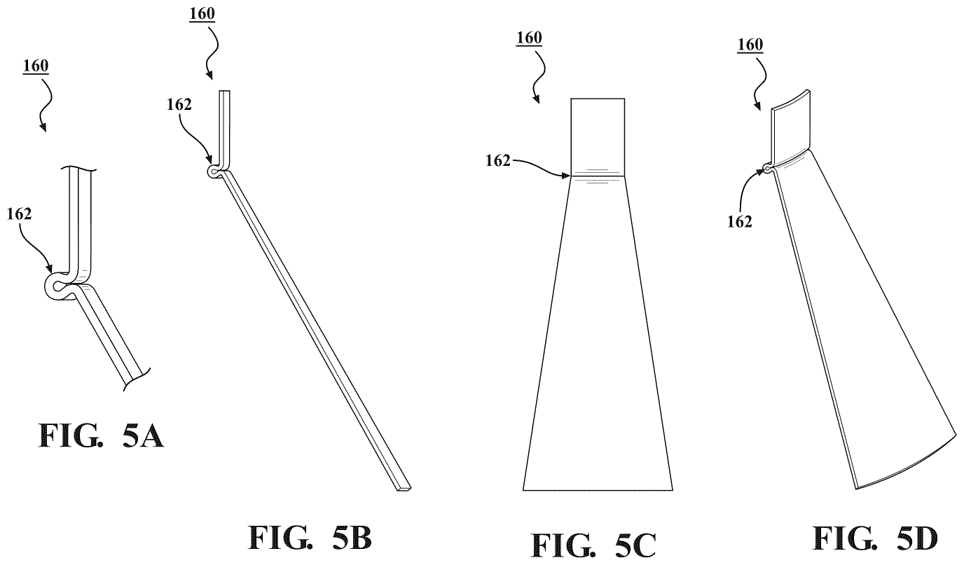

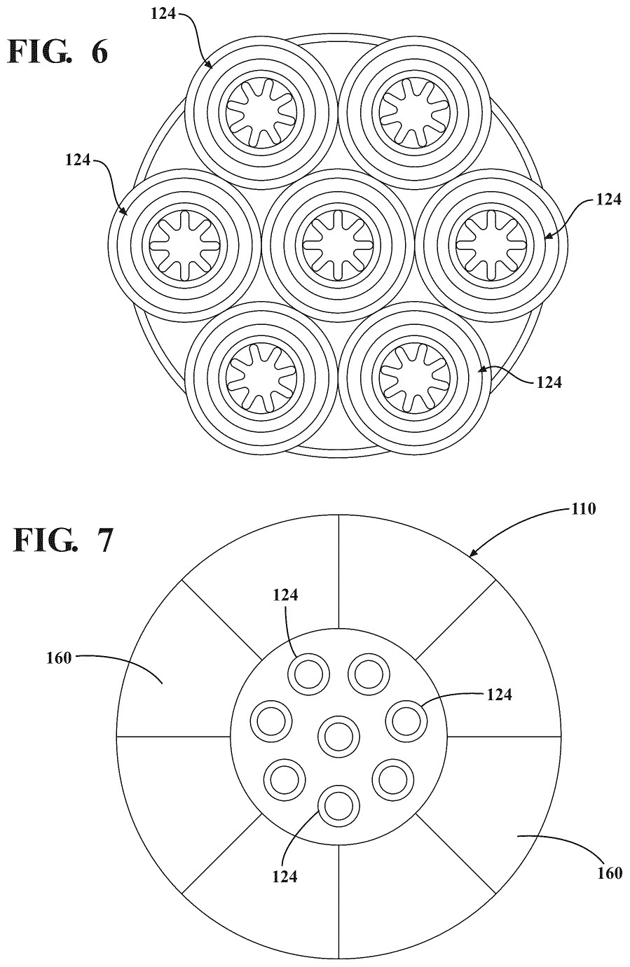

FIGS. 5A-5D provide[s] a plurality of views of individual fan blades 160 of the nozzle cone 110 in accordance with some aspects contemplated herein. As shown in FIGS. 5A-5D, each individual curved blade includes a live hinge 162. The nozzle cone 110 comprises a plurality of blades 162, nested against each other to form a wide cone when extended and retract into the body 102/152 of the hand-held solid animal waste disintegration apparatus 100/150 for easy portability.

As noted above, the hand-held solid animal waste apparatus 100/150 may include one or more nozzles 124 operable to expel the extremely-high pressure fluid to disintegrate solid animal waste. FIG. 6 provides a view of a plurality of nozzles 124 in accordance with some aspects of the subject disclosure. In some aspects, two (or more) settings for the nozzles 124 may be implemented. For example and without limitation, there may be a setting wherein the pressure is sufficient to disintegrate the animal feces. In another non-limiting example, a lower pressure setting may be available, wherein such a softer setting is operable to clean the nozzle 124 and the inside of the cone 110 after each use. As will be appreciated, the variable water pressures are issued forth for the two different purposes by modulating the water pressure with the pump control. In some aspects, such modulation may be achieved by varying the current sent to the pump 120 by the control module (that regulates the pump 120).

FIG. 7 provides an illustrative view of one or more nozzles 124 in combination with the cone 110 in accordance with some aspects contemplated herein. The cone 110 depicted in FIG. 7 is in its extended position, i.e., fanned out to cover the spray area for clean and safe operation. As discussed above, the one or more nozzles 124 are attached to telescoping tubes 122 to extend an adequate length to reach the ground, with the fan blades 160, as opposed to being nested in a lower section/portion of the body 102 of the hand-held solid animal waste apparatus 100/150. The telescoping tubes 122 may be implemented as spring-loaded, gravity-loaded, motorized, manually-operated, or the like. In some aspects, nozzle cone 110 may include a mechanism having a ring at the end (not shown) through which the fan blades 160 extend and expand as the ring space is wider than the ring hanging the fins above the nesting ring. By extending the fan blades 160, the cone 110 is formed via the aforementioned use of a live hinge to cover the animal feces prior to the application of high-pressure liquid. One or more of the plurality of nozzles 124 depicted in FIGS. 6 and 7 may be further configured to rotate, oscillate, or otherwise articulate to enable liquid expelled therefrom to contact, e.g., clean, the inside of the cone 110 of any debris. FIG. 8 illustrates various nozzle adapters 124, e.g., different sizes and/or strengths, which may be used depending on user preference and/or animal size.

Turning now to FIG. 9, there is shown a top view of the first end 104 of the hand-held solid animal waste apparatus 100/150 illustrating one aspect of the control panel 106. As illustrated in FIG. 9, the control panel 106 may be implemented with an on/off button 164. According to some aspects, the control panel 106 may further include a charging port 166 operatively coupled to the power supply 112 and configured to allow connection of the hand-held solid animal waste apparatus 100/150 to an external power source. It will be appreciated that while shown in FIG. 9 as a USB-C port, the charging port 116 may be any suitable standard-based or proprietary-based connection. The control panel 106 may further include a liquid, i.e., water fill port 168, and a fragrance fill port 170, each fluidly coupled to respective reservoirs 114 and 116. In some aspects, the ports 168 and 170 may be configured with washers, gaskets, friction-seals, or the like, to ensure that any liquids deposited therethrough do not leak when the hand-held solid animal waste apparatus 100/150 is moved, used, etc.

The example control panel 106 shown in FIG. 9 may also include one or more level indicators, e.g., illuminated, mechanical, or electro-mechanical gauges, operative to indicate to a user the current status of one or more components of the hand-held solid animal waste apparatus 100/150. For example, as illustrated in FIG. 9, the control panel 106 may include a fragrance level indicator 172, a water level indicator 174, and a battery level indicator 176. In such implementations, the aforementioned indicators 172-174 may provide a visual depiction of the amount of water available, the amount of fragrance available, the battery power remaining, or the like. It will be appreciated that other indicators may be included, e.g., number of disposals remaining, nozzle-replacement warning, nozzle cleaning warning, in-use indicator, or the like, and the illustration in FIG. 9 is intended only as one non-limiting example illustrating some of the aforementioned indicators capable of being included on the control panel 106.

The control panel 106 illustrated in FIG. 9 may further include one or more device operation controls relating to the functioning of the hand-held solid animal waste apparatus 100/150 in accordance with some aspects contemplated herein. As shown, the example control panel 106 includes a clean switch 178, an extend switch 180, and a vaporize switch 182. The use of the term “switch” is intended to identify any component capable of activating an operation of the hand-held solid animal waste apparatus 100/150, including, for example and without limitation, touch-sensitive display icons, bubble switches, buttons, toggle-switches, piezoelectric-mechanical switches, and the like. The pressing of the clean switch 178 may activate certain pre-programmed operations of the hand-held solid animal waste apparatus 100/150 causing the pump 120 (and/or motor 118) to activate and generate a suitable water stream through the one or more nozzles 124 at a suitable pressure to effectuate cleaning of the one or more nozzles 124 and/or interior of the cone 110. Activation of the extend switch 180 may activate any suitable electric, mechanical (spring-loaded), or gravity-based mechanism to extend the tube 122 (and the associated cone 110 and nozzle(s) 124) to the operational position of the hand-held solid animal waste apparatus 100/150. In some aspects, subsequent activation of the extend switch 180 may also function to cause the retraction of the tube 122 of the hand-held solid animal waste apparatus 100/150 to the storage/stowage position. It will be appreciated that in some aspects, e.g., gravity or spring-based, subsequent activation of the extend switch 180 may serve to release any internal locking mechanism (not shown) to keep the tube 122 in a rigidly extended position. Further, the vaporize (or disintegrate) switch 182 of the control panel 106 may serve to activate certain pre-programmed operations of the hand-held solid animal waste apparatus 100/150 causing the pump 120 (and/or motor 118) to activate and generate a suitable water stream through the one or more nozzles 124 at a suitable pressure to effectuate disintegration of any solid animal waste.

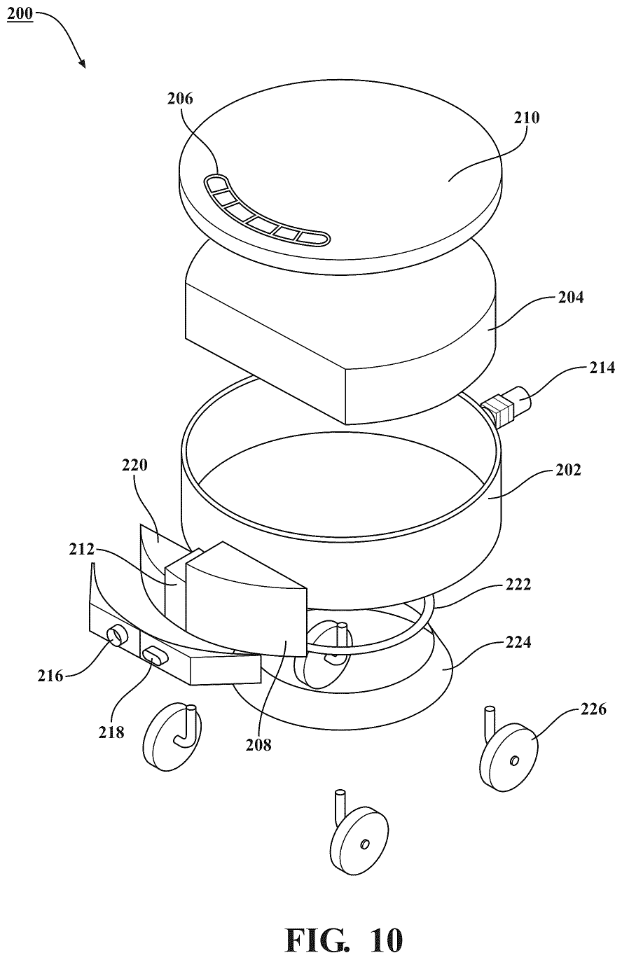

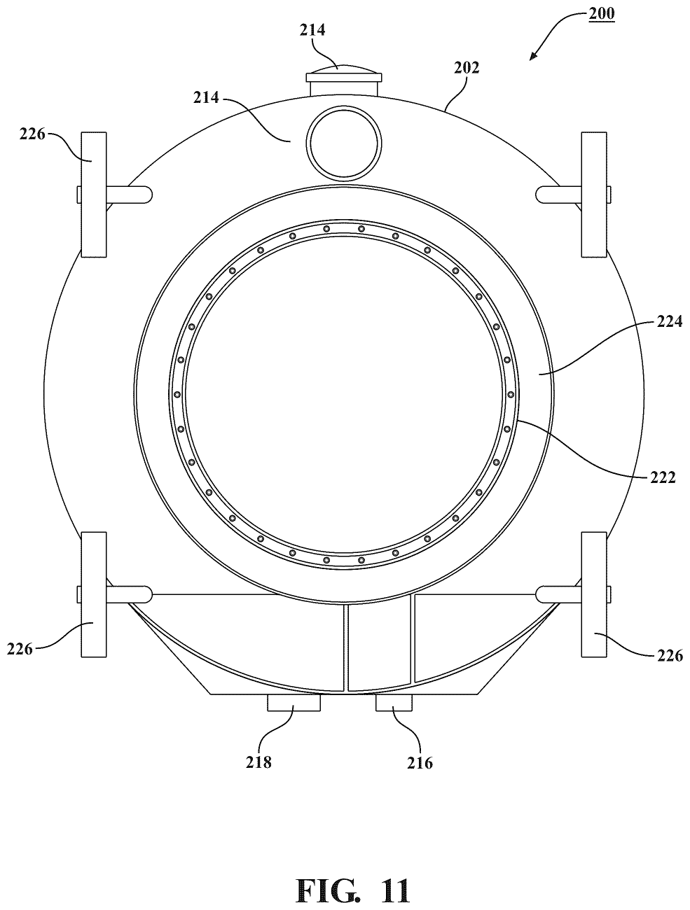

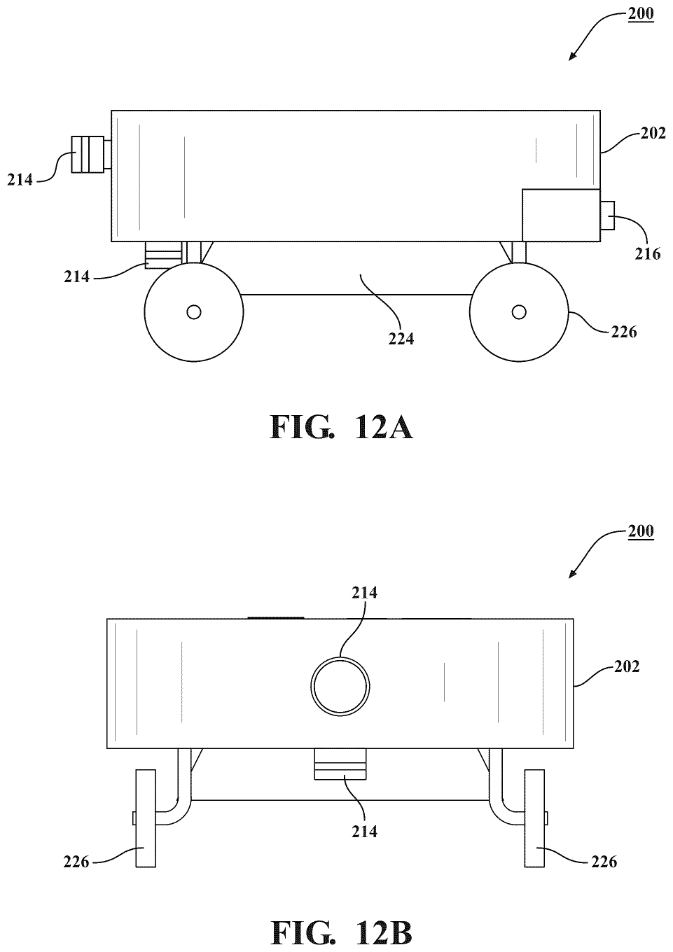

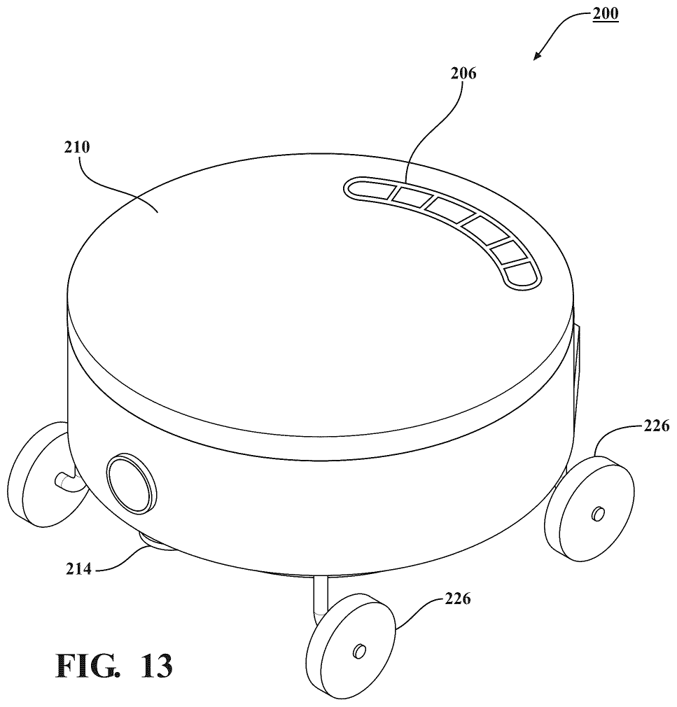

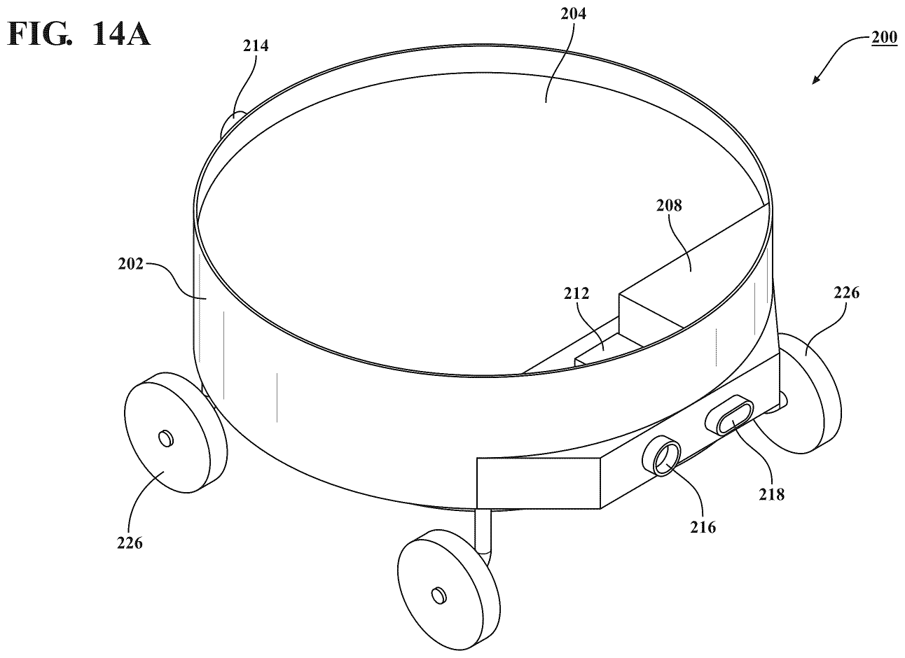

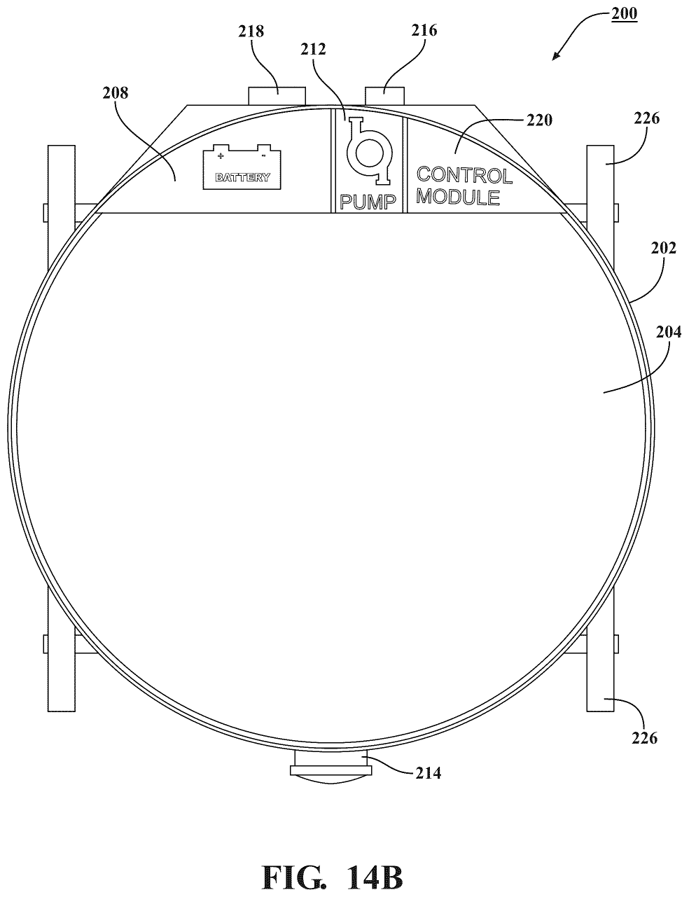

Turning now to FIGS. 10-14B, there is shown an exploded view of a solid animal waste disintegrator roamer 200 in accordance with some aspects contemplated herein. According to some aspects contemplated herein, the solid animal waste disintegrator roamer 200 may comprise an autonomous, semi-autonomous, or remote controlled vehicle configured with various components similar to the hand-held apparatus 100/150 described above. As illustrated in FIGS. 10-14B, the roamer 200 includes a body 202, a water reservoir 204, a control panel 206, a power supply 208, a top cover 210, a controller 212, camera 214, water inlet 216, charging port 218, pump 220, nozzles 222, nozzle cone 224, wheels 226, and the like. It will be appreciate that additional components may be included in the roamer 200 depending upon usage requirements, and such additional components may include, for example and without limitation, additional displays, high-pressure tubing, low-pressure tubing, motors, controls, power supplies, fragrance reservoirs, guidance systems, air compressors, heating elements, air drying nozzles, and the like.

As depicted in FIGS. 10-14B, the body 202 may be implemented in a substantially cylindrical shape, however, the skilled artisan will appreciate that other shapes, e.g., boxed, triangular, ovoid, etc., may also be utilized in accordance with varying aspects disclosed herein. The body 202 generally includes a liquid reservoir 204 positioned therein, and configured to store a liquid, e.g., water, which may be pressurized for disintegration of solid animal waste. As shown in FIGS. 10-14B, the reservoir 204 is configured as a removable/self-contained component inserted into a cavity 205 of the body 202. In some aspects, the reservoir 204 may be implemented as a tank formed, i.e., integrally, within the cavity 205 of the body 202, and the illustration of the reservoir 204 as a separate component inserted into the cavity 205 is intended solely as one non-limiting example thereof.

The roamer 200 further includes a top cover 210 enclosing the cavity 205 of the body 202, as shown in FIGS. 10-14B. A control panel 206 is located on the outer surface of the top cover 210, configured to receive and display information from and to an associated user. In some aspects, the control panel 206 may be implemented with the same control components described above with respect to FIG. 9, including, for example and without limitation, an on/off switch, a battery/power level indicator, a water level indicator, a fragrance level indicator, a vaporize/disintegrate switch, a pairing switch (e.g., NFC, Bluetooth, WiFi, I/R, or other device-pairing-networking communication medium), and the like. In some aspects, the control panel 206 is communicatively coupled to the controller 212, as discussed in greater detail below.

As illustrated in FIGS. 10-14B, the body 202 of the roamer 200 may be equipped with one or more cameras 214, configured to capture image data for navigation, waste identification, disintegration guidance, and the like. As shown in in FIGS. 10-14B, one of the cameras 214 may be positioned on a forward portion of the body 202 of the roamer 200, on the underside of the roamer 200 facing downward (e.g., toward the ground), on the sides of the roamer 200, the rear of the roamer 200, and the like. While two cameras 214 are depicted in FIG. 10, the skilled artisan will appreciate that multiple cameras 214 or a single camera 214 may also be implemented. Cameras 214 may be implemented as capable of capturing a variety of wavelengths, including, for example and without limitation, infrared, near infrared, visible spectrum, or the like. The one or more cameras 214 may be communicatively coupled to the controller 212, which may be configured to process the image data received therefrom for one of the one or more functions referenced above.

The roamer 200 of FIGS. 10-14B further includes a power supply 208 positioned within the cavity 205. In some embodiments, the power supply 208 may be implemented as a rechargeable or disposable battery, including, for example and without limitation, a lithium-ion battery, nickel-cadmium battery, alkaline battery, fuel cell, or other suitable power storage or generation device, as will be appreciated. The power supply 208 may be suitably sized to provide power to the various components of the roamer 200, e.g., the control panel 206, the controller 212, one or more cameras 214, pump 220, nozzle cone 224, wheels 226, etc.

The power supply 208 is electrically coupled to the pump 220, which may be implemented as, for example and without limitation, a linear intensifier pump, or a high-pressure water jet pump, or a hyper-jet ultrahigh-pressure pump, a hydraulic pressure intensifier, or the like. The pump 220 may be configured to provide varying levels of pressure, from minimal pressure (e.g., spraying fragrance) to extremely high-pressure (e.g., disintegration pressure). The pump 220 may be configured to produce a spray of liquid with a fluid pressure at the nozzle 222 of about 800 to 1500 PSI, and in some implementations, a fluid pressure of about 1000 PSI. In producing such pressures, the pump 220 may be configured to have a flow rate in the range of about 0.05 to 0.15 gallons per minute (GPM), and in some implementations, have a flow rate greater than or equal to 0.1 GPM.

The roamer 200 shown in FIGS. 10-14B further includes a water inlet 216 positioned on an external surface of the body 202 and fluidly coupled to the water reservoir 204. In some aspects, the water inlet 216 is configured to couple with a hose, faucet, or other liquid connection to enable filling and/or draining of the water reservoir 204. As illustrated in FIGS. 10-14B, the water inlet 216 may be positioned on a side of the body 202, opposite the position of the camera 214. In other aspects, the water inlet 216 may be positioned on the top cover 210, positioned directly on the water reservoir 204, or the like. A charging port 218 operatively coupled to the power supply 208 is positioned on an external surface of the body 202, as shown in FIGS. 10-14B. In some aspects, the charging port 218 may be configured to allow connection of the solid animal waste roamer 200 to an external power source. It will be appreciated that the charging port 218 may be any suitable standard-based or proprietary-based connection. In some aspects, the inlet 216 and charging port 218 may be configured with washers, gaskets, friction-seals, or the like, to ensure that any liquids deposited therethrough do not leak out and, when used in wet environments, liquids do not penetrate into the roamer 200, and the like.

Fluidly coupled to the pump 220 are one or more nozzles 222 positioned on the underside of the roamer 200, surrounded by a nozzle cone 224, and configured to expel a high-pressure stream of fluid from the pump 220 to effectuate the disintegration of solid animal waste. As shown in FIGS. 10-14B, the one or more nozzles 222 may be positioned in a ring, angled to expel the high-pressure stream of fluid onto solid animal waste. As described above with respect to the hand-held apparatus 100/150, the nozzles 222 of the roamer 200 may be configured with two (or more) settings. For example and without limitation, there may be a setting wherein the pressure is sufficient to disintegrate the animal feces. In another non-limiting example, a lower pressure setting may be available, wherein such a softer setting is operable to clean the nozzles 222 and the inside of the cone 224 after each use. As will be appreciated, the variable water pressures are issued forth for the two different purposes by modulating the water pressure with the pump control. In some aspects, such modulation may be achieved by varying the current sent to the pump 220 by the controller 212.

In some aspects, the nozzle cone 224 surrounding the one or more nozzles 222 is configured to cover any animal waste to facilitate safe operation where high-pressure liquid (e.g., water) jet(s) will be output through the one or more nozzles 222 via the pump 220 to disintegrate the animal waste. In operation, the nozzle cone 224 may be movable, configured to extend downward or retract upwards into the body 202 of the roamer 200. In some aspects, the nozzle cone 224 is disposable and/or replaceable. In other aspects, a cleaning operation may be performed via the nozzles 222 to clean any debris, e.g., disintegrated waste material, from the interior of the nozzle cone 224. In such a cleaning operation, various aspects contemplated herein may provide for one or more nozzles 222 to articulate, rotate, or otherwise move to enable liquid to contact the interior of the nozzle cone 224, thereby cleaning the nozzle cone 224 of any extraneous waste located therein. The nozzle cone 224 may be constructed of a plurality of fan blades similar to those described above with respect to FIGS. 5A-5D. As such, similar construction of the nozzle cone 224 relative to the nozzle cone 110 is contemplated herein.

The roamer 200 of FIGS. 10-14B further includes wheels 226 configured to provide motive means to the roamer 200, allowing movement thereof. In some aspects, the wheels 226 include individual motors (not shown) configured to turn the wheels 226, pivot the wheels 226 (for steering) or a combination thereof. In other aspects, the wheels 226 may be coupled to a single motor via various gearing, drives, transmissions, belts, chains, or the like. Control of the wheels 226, and correspondingly, movement of the roamer 200 may be accomplished via the controller 212. The wheels 226 may be electrically connected to the power supply 208, with such power being controlled via the controller 212. Although illustrated with wheels 226, the roamer 200 may be implemented with other motive means, e.g., tracks, legs, etc., and the use of wheels 226 in FIGS. 10-14B is intended solely as one non-limiting example thereof.

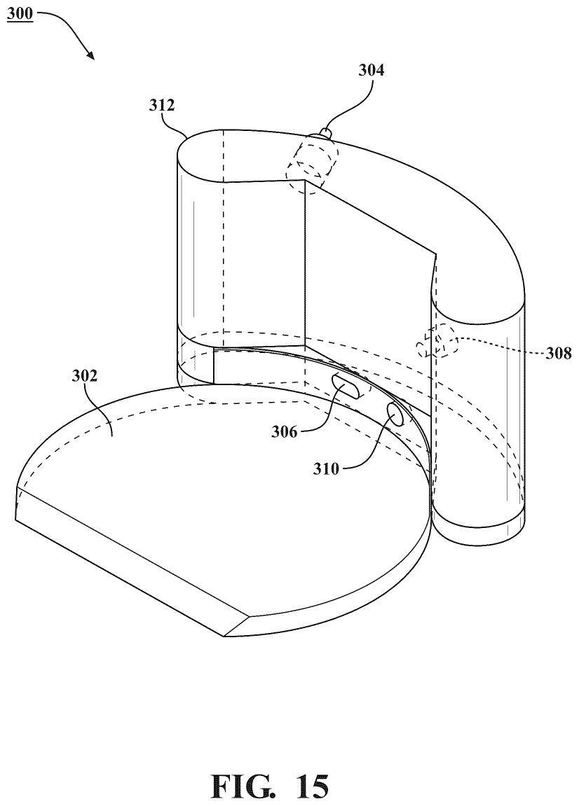

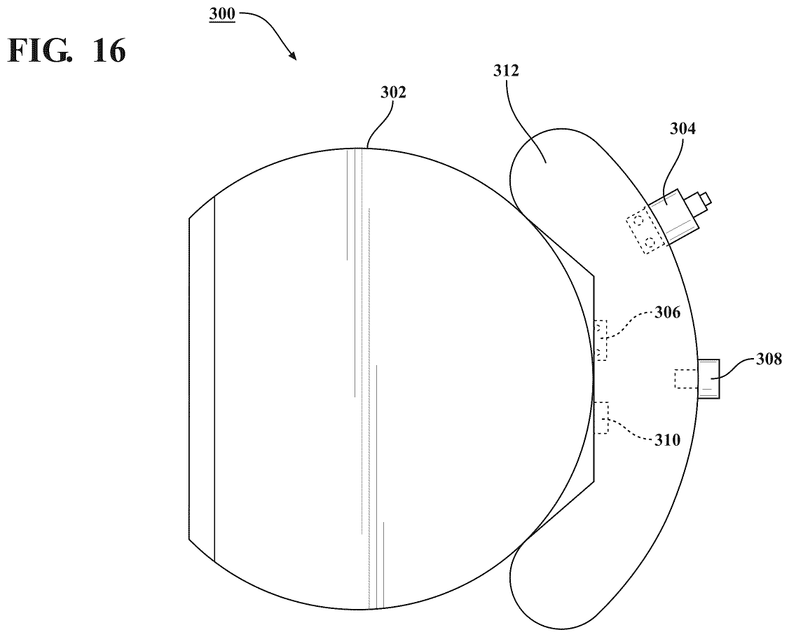

In some aspects, the solid animal waste disintegration roamer 200, for example when operating autonomously, may require recharging of the power supply 208, e.g., battery. In such aspects, a charging pad component 300 may be provided to enable recharging of the power supply 208 and/or refilling of the water reservoir 204, fragrance reservoir, or other consumables. Accordingly, the combination of the solid waste disintegration roamer 200 and charging pad component 300 provide an example of a system for solid animal waste disintegration in accordance with some aspects contemplated herein. FIGS. 15 and 16 provide illustrative views of an example of a charging pad component 300 in accordance with such aspects. As shown in FIGS. 15-16, the charging pad 300 includes base portion 302 and a resupply tank 312. The charging pad 300 includes an electrical connection 304 to which an external power line may be communicatively coupled and a resupply inlet 308 to which a hose may be coupled to supply water or other liquid to the resupply tank 312. Positioned at the bottom of the resupply tank 312 and proximal to the base portion 302 are a charging connection 306 and water outlet 310. The charging pad 300 is configured to receive the roamer 200 thereon, aligning the charging port 218 of the roamer 200 with the charging connection 306, and the water inlet 216 of the roamer 200 with the water outlet 310. When connected, the roamer 200 may be configured to recharge the power supply 208 and water reservoir 204 from the charging pad 300. In some aspects, additional respective connections may be provided, allowing for the replenishment of other consumables, e.g., fragrances, etc.

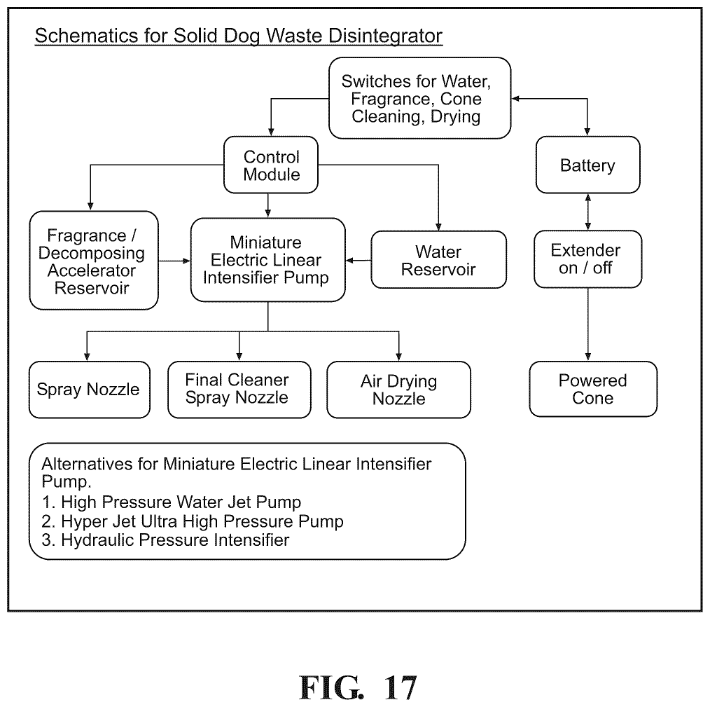

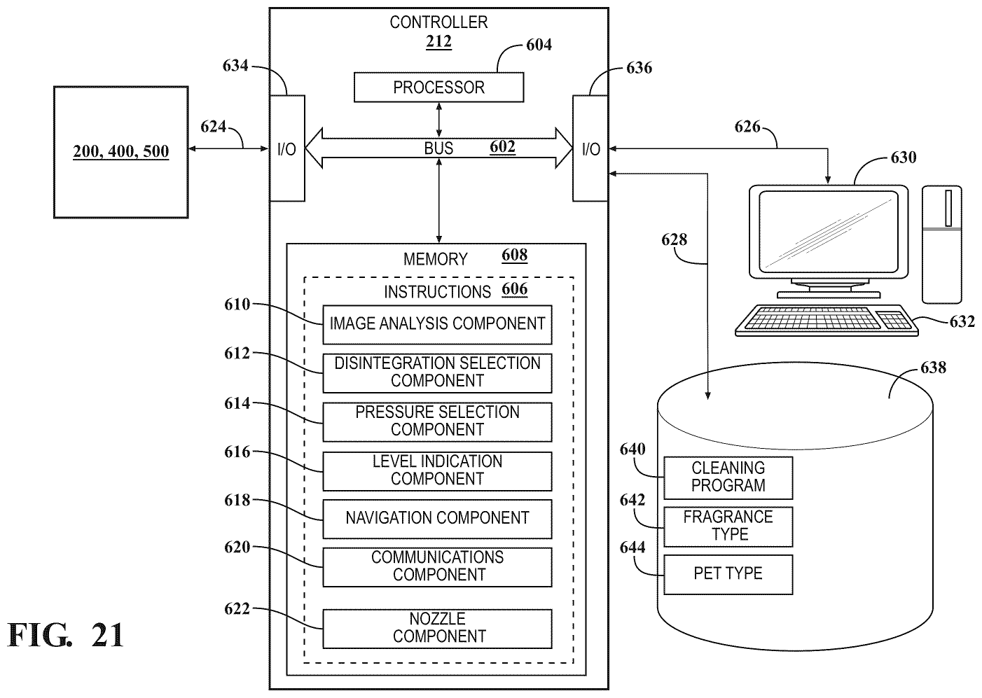

FIG. 17 provides an illustrative block diagram of various components of the roamer 200 in accordance with one example aspect contemplated herein. Interaction of the various components shown in FIG. 17 will be better understood in conjunction with FIG. 21 discussed in greater detail below.

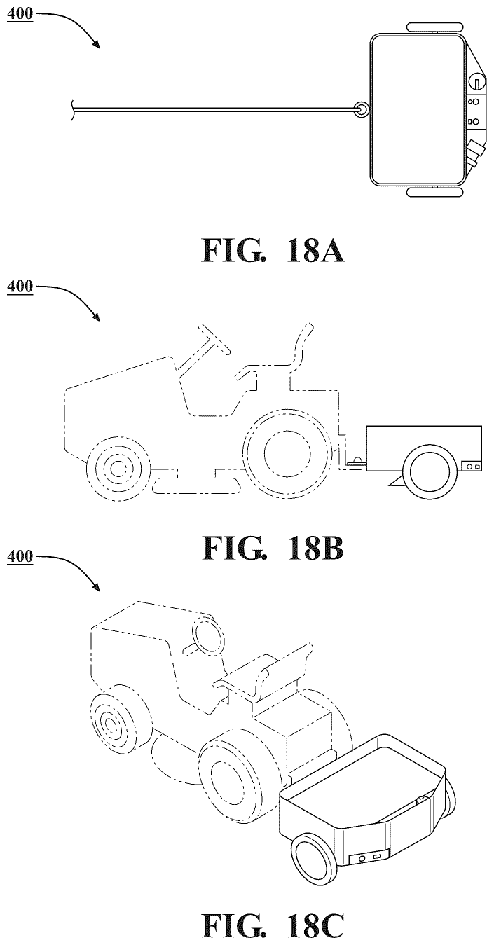

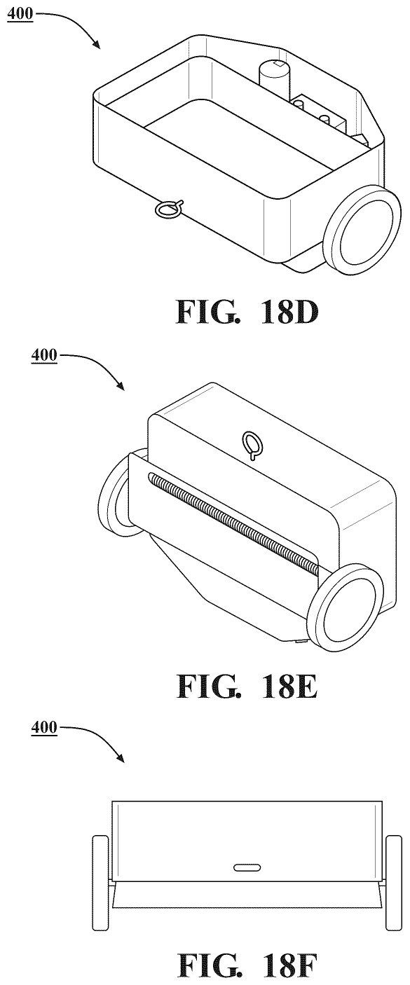

FIGS. 18A-18F provide an illustration of another example embodiment contemplated herein. As shown therein, a tractor may be used as an attachment point, wherein the tractor includes a towed animal solid waste disintegration apparatus 400 attached to a standard tractor attachment point. As shown in FIGS. 18A-18F, the apparatus 400 includes one or more cameras, pumps, nozzles, nozzle cones, water reservoir, etc., configured to detect and disintegrate animal waste as discussed above. In some aspects, the apparatus 400 may include multiple disintegration components to allow for wide disintegration, e.g., a pasture or pen.

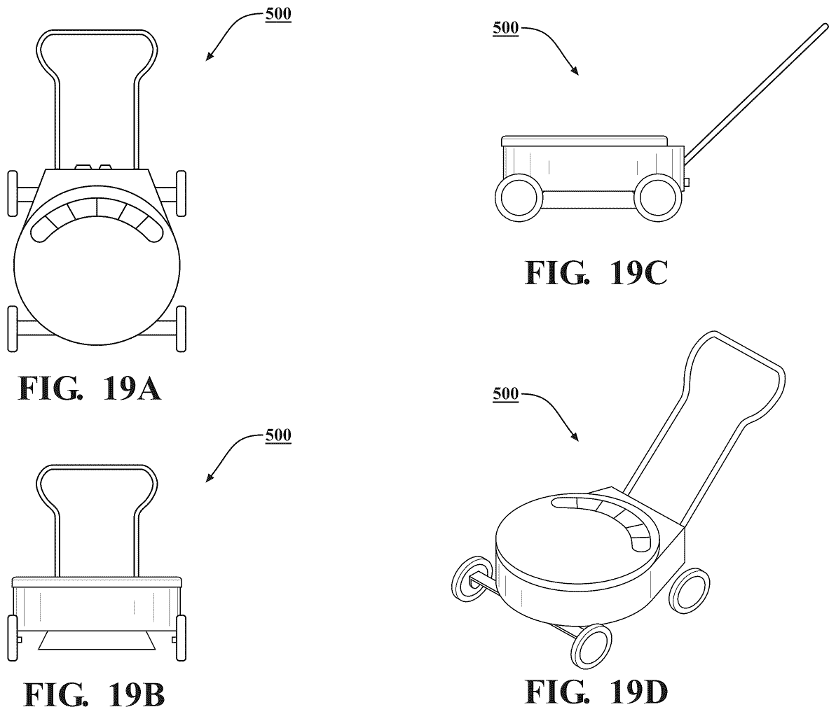

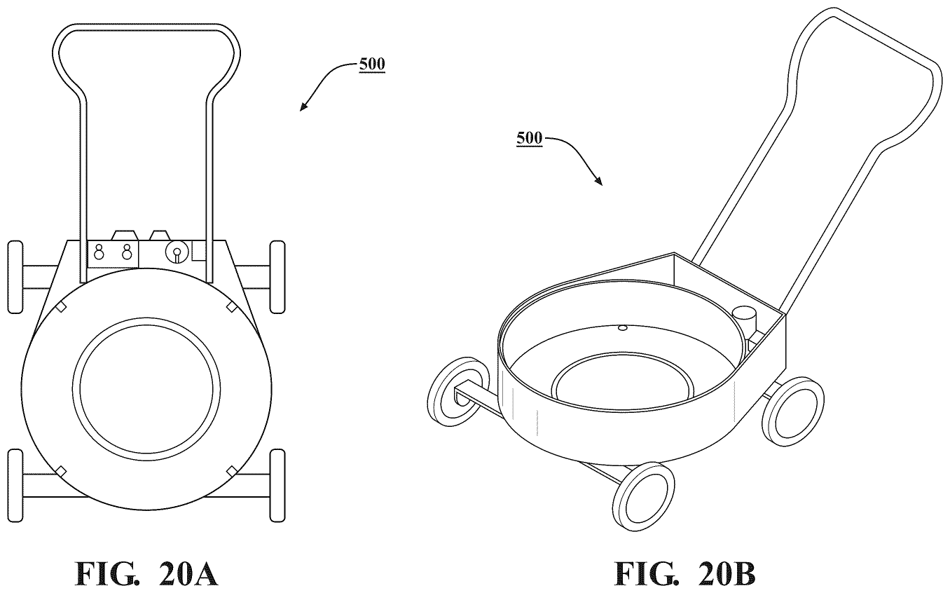

FIGS. 19A-20B provide an illustration of another example embodiment contemplated herein. As shown therein, a walk-behind (i.e., manually propelled) animal solid waste disintegration apparatus 500 includes one or more cameras, pumps, nozzles, nozzle cones, etc., configured to detect and disintegrate animal waste as discussed above. The walk-behind animal solid waste disintegration apparatus 500 may be implemented with a substantially larger capacity water reservoir or a hose attachment. In some aspects shown in FIGS. 18A-20B, the nozzles utilized therein may be arranged in a linear fashion, e.g., multiple rows of nozzles to allow for large-scale disintegration of solid animal wastes.

As noted above, operations of the roamer 200 may be accomplished in accordance with direction from a controller 212. Turning now to FIG. 21, there is shown an example diagram of such a controller 212 in accordance with some aspects contemplated herein. It will be appreciated that while reference is made hereinafter to actions and operations of the roamer 200, the controller 212 as described below may have operative control operations of any of the embodiments described above, and the discussion with respect to the roamer 200 is not intended as limiting such operations. As shown in FIG. 21, the controller 212, which is capable of implementing the methods set forth herein, includes a processor 604, which performs an example method by execution of processing instructions 606 that are stored in memory 608 connected to the processor 604, as well as controlling the overall operations of the solid animal waste disintegration roamer 200, 400, 500. The various components of the controller 212 may be connected by a data/control bus 602. The processor 604 of the controller 212 may be in communication with an associated database 638 via a suitable communications link 628. A suitable communications link 628 may include, for example, a switched telephone network, a wireless radio communications network, infrared, optical, or other suitable wired or wireless data communications. The database 638 is capable of implementation on components of the controller 212, e.g., stored in local memory 608, e.g., on hard drives, virtual drives, or the like, or on remote memory accessible to the controller 212. It will be appreciated that while depicted in FIG. 21 as a single device, the controller 212 may be representative of a cloud-based computing, e.g., distributed processing system, and the illustration of the controller 212 as a single device is intended solely as a non-limiting illustrative example.

The associated database 638 is representative of any organized collections of data (e.g., cleaning programs 640, fragrance types 642, animal/pet type 644, etc.) used for one or more purposes. The skilled artisan will appreciate that such information may be updated via machine learning during operations of the subject system. Implementation of the associated database 638 is capable of occurring on any mass storage device(s), for example, magnetic storage drives, a hard disk drive, optical storage devices, flash memory devices, or a suitable combination thereof. The associated database 638 may be implemented as a component of the controller 212, e.g., resident in memory 608, or the like. In one embodiment, the associated database 638 may include data corresponding to pre-planned routes, obstacles, terrain, feces consistency, feces type, power requirements, pressure, nozzle type, nozzle configuration, nozzle size, water capacity, fragrance capacity, etc.

The controller 212 may include one or more input/output (I/O) interface devices 634 and 636 for communicating with external devices. The I/O interface 636 may communicate, via communications link 626, with one or more of a display device 630, for displaying information, possible cleaning programs, start/stop times, etc., and a user input device 632, such as a keyboard or touch or writable screen, for inputting text, and/or a cursor control device, such as mouse, trackball, or the like, for communicating user input information and command selections to the processor 604. The I/O interface 634 may communicate with external devices such as a user device (e.g., a mobile communications device, IoT device, and the like), via a suitable the communications link 624. In some aspects contemplated herein, the display device 630 and the user input device 632 may be combined into a single device, e.g., a smart phone, tablet, etc. The I/O interface 634 may be implemented as a suitable transceiver capable of establishing bi-directional communication with external devices. In such aspects, the communications link 624 may be implemented as a near-field or personal area network, e.g., BLUETOOTH or other suitable short-range wireless technology standard. In other aspects, such a communications link 624 may be an infra-red or near infra-red wireless communication link.

It will be appreciated that the controller 212 illustrated in FIG. 21 is capable of implementation using a distributed computing environment, such as a computer network, which is representative of any distributed communications system capable of enabling the exchange of data between two or more electronic devices. It will be further appreciated that such a computer network includes, for example and without limitation, a virtual local area network, a wide area network, a personal area network, a local area network, the Internet, an intranet, or any suitable combination thereof. Accordingly, such a computer network comprises physical layers and transport layers, as illustrated by various conventional data transport mechanisms, such as, for example and without limitation, Token-Ring, Ethernet, or other wireless or wire-based data communication mechanisms. Furthermore, while depicted in FIG. 21 as a networked set of components, the controller 212 is capable of implementation on a stand-alone device.

The controller 212 may include one or more of a computer server, workstation, personal computer, cellular telephone, tablet computer, pager, combination thereof, or other computing device capable of executing instructions for performing the exemplary method.

According to one example embodiment, the controller 212 includes hardware, software, and/or any suitable combination thereof, configured to interact with an associated user, a networked device, networked storage, remote devices, or the like.

The memory 608 illustrated in FIG. 21 as a component of the controller 212 may represent any type of non-transitory computer readable medium such as random access memory (RAM), read only memory (ROM), magnetic disk or tape, optical disk, flash memory, or holographic memory. In one embodiment, the memory 608 comprises a combination of random access memory and read only memory. In some embodiments, the processor 604 and memory 608 may be combined in a single chip. The network interface(s) 634, 636 allow the computer to communicate with other devices via a computer network, (e.g., the Internet), and may comprise a modulator/demodulator (MODEM). Memory 608 may store data processed in the method as well as the instructions for performing the exemplary method.

The processor 604 can be variously embodied, such as by a single core processor, a dual core processor (or more generally by a multiple core processor), a digital processor and cooperating math coprocessor, a digital controller, or the like. The processor 604, in addition to controlling the operation of the controller 212, executes instructions 606 stored in memory 608 for performing the method set forth hereinafter.

As shown in FIG. 21, the instructions 606 stored in memory 608 may include an image analysis component 610, configured to receive and process images captured by the one or more cameras 214. In some aspects, the image analysis component 610 may be configured to process one or more images captured by the one or more cameras 214 to identify solid animal waste, terrain, obstacles, and the like. According to other aspects, the image analysis component 610 may communicate with other internal components to effectuate operations of the roamer 200, as will be appreciated in view of the description presented herein.

The instructions 606 stored in memory 608 may further include a disintegration selection component 612 that is configured to determine, in accordance with an output from the image analysis component 610, a disintegration level associated with identified solid animal waste. That is, the disintegration selection component 612 may receive and analyze the data from the image analysis component 610 to identify moisture content/consistency of the solid animal waste and associate that identification with a needed level of disintegration. For example, for waste with high moisture content, the amount of disintegration needed may be lower than that of waste with a low moisture content. In some aspects, the disintegration component 612 may be configured to determine an amount of liquid required for reducing the solid animal waste to particulates capable of being absorbed by the underlying soil or dispersed into the atmosphere.

Additionally, the instructions 606 in memory 608 may also include pressure selection component 614, which is configured to select the pressure of liquid expelled by the one or more nozzles 222 in accordance with a determined disintegration level (from the disintegration selection component 612) to disintegrate solid animal waste. Such pressure selections may include, for example and without limitation, ranges of about 800 to 1500 PSI, and in some implementations, a fluid pressure of about 1000 PSI. In some aspects, the pressure selection component 614 may be configured to direct the pump 220 may be configured to have a flow rate in the range of about 0.05 to 0.15 gallons per minute (GPM), and in some implementations, have a flow rate greater than or equal to 0.1 GPM. In some aspects, the pressure selection component 614 may control operations of the pump 220 in conjunction with the nozzle component 622, as discussed below.

The instructions 606 stored in memory 608 may further include a level indication component 616 configured to analyze the amount of fluid in the water reservoir 204, the fragrance reservoir, a power level associated with the power supply 208, or other consumables or resources of the roamer 200. In some aspects, the level indication component 616 may communicate such levels, e.g., battery level, water level, fragrance level, to the control panel 206, a remote user device (e.g., mobile phone, tablet, remote control, etc.), or the like. One or more sensors (not shown) may be used by the roamer 200 to send signals to the level indication component 616 from which the aforementioned levels may be determined, e.g., pressure sensors, limit switches, flow meters, multimeters, heat sensors, MEMS devices, and the like.

The instructions 606 stored in memory 608 further include a navigation component 618 configured to control operations of the wheels 226 and movement of the roamer 200 accordingly. In some aspects, the navigation component 618 may utilize image data received from the image analysis component 610 to move the roamer 200 to/away from solid animal waste, avoid obstacles, follow a predefined path, etc. The navigation component 618 may further be configured to receive global positioning signals (GPS), other satellite navigation signals, radio tower triangulation signals, geo-fencing, geo-mapping, etc., to enable preprogrammed movement of the roamer 200 through an area to detect, identify and disintegrate solid animal waste. According to some aspects, the navigation component 618 may communicate commands to a motor controller (not shown) associated with the wheels 226, effectuating movement and/or pivoting thereof.

In some embodiments, the controller 212 may include instructions 606 stored in memory 608 that include a communications component 620. In such embodiments, the communications component 620 may be configured to communicate with one or more external, e.g., remote devices, receive instructions from such remote devices, and the like. According to some aspects, a mobile device (not shown) running an app may remotely control operations of the roamer 200 or other embodiments, e.g., 400, 500. For example, a user may, via the mobile device, send a remote command to the controller 212 via a computer network or other communications medium indicating that operations of the roamer 200 to begin a preprogrammed route for identification and disintegration of solid animal waste is to be conducted at a certain time on a certain day. The communications component 620 receives this information, and in conjunction with the other components 610-618 described above, facilitates operations of the roamer 200 such that the cleaning, e.g., solid animal waste disintegration operation(s) will be performed at the preselected time.

Additionally, the instructions 606 stored in memory 608 of the controller 212 may include a nozzle component 622 configured to control operations of the nozzles 222 and nozzle cone 224. In some aspects, the nozzle component 622 may be configured to control extension and retraction of the nozzle cone 224 in accordance with image data indicating a presence of solid animal waste received from the image analysis component 610. That is, when solid animal waste is detected and identified, the roamer 200, via the navigation component 618, moves to the animal waste and orientates the nozzles 222 and nozzle cone 224 above the solid animal waste. The nozzle component 622 may then be configured to direct the nozzle cone 224 to extend downward, encapsulating or covering the solid animal waste. In some implementations, the nozzle cone 224 may be configured to have an extension less than or equal to the distance between the bottom of the body 202 and the ground over which the roamer 200 rests. Stated another way, the nozzle cone 224 may extend the height of the wheels 226 to prevent any materials from escaping from the disintegration operation. The nozzle component 622 may also be configured to control operations of the nozzles 222. During a cleaning operation of the roamer 200, the nozzle component 622 may control orientation of the nozzles 222 (e.g., angle, pitch, rotations), control flow through the nozzles 222, etc. For example, in accordance with the pressure selection component 614, the nozzle component 622 may control operations of the nozzles 222 and pump 220 to enable the nozzles 222 to expel fluid at the selected pressure, e.g., disintegration, cleaning, fragrance, etc.

According to various aspects contemplated herein, the solid animal waste disintegrator hand-held apparatus, roamer, and method provided herein renders disposal of animal feces a user-friendly and eco-friendly task, which is convenient, efficient, effective, and friendly to the environment.

According to various aspects contemplated herein, the solid animal waste disintegrator hand-held apparatus, roamer, and method provided herein may include a fragrance dispenser/reservoir that can dispense a stream of chosen fragrance or odor neutralizer. The fragrance reservoir may utilize the same high-pressure mechanism described above. The mixing of the fragrance may be achieved with a valve control mechanism, which combines the fragrance with certain amounts of water to be sent to the nozzle, such that the fragrance and water will be vaporized to achieve the desire effect of better smells. The control button for fragrance sends a signal to the control module, which then regulates the amount of water and fragrance issued from the water reservoir and the fragrance reservoir by the use of a valve. An alternative fragrance disbursement method contemplated herein includes use of an aerosol spray canister instead of the fragrance reservoir, which can be replaced and replenished. If a fragrance is used, then there is no need for valve control or mixing the water, where the control is accomplished by the use of a manual trigger.

According to various aspects contemplated herein, the solid animal waste disintegrator hand-held apparatus, roamer, and method provided herein may include a leash winder, so the dog owner can walk the dog with the leash and then, when needed, use the wand to disintegrate the animal feces.

According to various aspects contemplated herein, the solid animal waste disintegrator hand-held apparatus, roamer, and method provided herein may include an additive that may be applied to assist in the decomposition of the dog solid waste. This can be applied instead of the fragrance in the same mechanism.

According to various aspects contemplated herein, there is provided a hand-held device for any animal feces disintegration. The hand-held device includes a battery-driven mechanism to generate high-pressure water streams, utilizing a miniature version of one of the four high-pressure-generating pumps, i.e., electric linear intensifier pump, electric high-pressure water jet pump, electric hyper jet ultra-high-pressure pump, electric hydraulic intensifier pump, to disintegrate solid animal waste. The hand-held device includes a liquid reservoir with attached dispenser for fragrance or added chemicals, to be misted at a certain setting by the high-pressure electric water pump. The hand-held device may include a wand with on/off switch for high-pressure liquid activation and on/off switch for fragrance or added chemicals. The hand-held device may also include a nozzle cone that can expand and close to cover the animal feces in the process of disintegration. The nozzle cone may further include an extension mechanism that can extend the nozzle cone down to the ground and supply either the water stream or the fragrance or chemical, and retract to fold into the device. The hand-held device may also enable a secondary stream that can clean the cone when lifted from the waste disintegration site that is activated via clean button.

In some embodiments, the present disclosure relates to a method of assembling the various components of the solid animal waste disintegration apparatus 100 shown and described herein.

In some embodiments, the present disclosure relates to a method of assembling the various components of the solid animal waste disintegration device 200 shown and described herein.

In some embodiments, the present disclosure relates to a method of using the solid animal waste disintegration apparatus 100 shown and described herein.

In some embodiments, the present disclosure relates to a method of using the solid animal waste disintegration device 200 shown and described herein.

In some embodiments, the present disclosure relates to a method of controlling the solid animal waste disintegration device 200 shown and described herein.

Based on the foregoing, it should now be understood that the present disclosure relates to a hand-held device, a roamer device, a walk-behind device, and a towed device that facilitates the disintegration of solid animal waste using high-pressure streams of fluid.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular aspects have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A solid animal waste disintegration roamer, comprising:
a body, including:
a cavity formed within the body,
a first fluid reservoir disposed within the body,
a pump fluidly coupled to the reservoir within the body,
at least one camera disposed on an exterior surface of the body, and
a power supply electrically coupled to the pump;
a retractable nozzle cone disposed on a bottom surface of the body, the nozzle cone configured to extend downward and retract upward in accordance with a disintegration operation;
at least one nozzle positioned on the bottom surface of the body, the at least one nozzle disposed within the nozzle cone and in fluid communication with the pump, wherein the at least one nozzle is configured to expel at least one of a high-pressure or a low-pressure fluid; and
a controller comprising a processor in communication with memory storing instructions which are executed by the processor to:
analyze image data captured by the at least one camera to identify solid animal waste,
extend the retractable nozzle cone downward over the identified solid animal waste, and
activate the pump to expel at least one of the high-pressure fluid or the low-pressure fluid through the at least one nozzle to disintegrate the identified solid animal waste.

2. The solid animal waste disintegration roamer of claim 1, wherein the pump comprises at least one of a linear intensifier pump, a high-pressure water jet pump, a hyper-jet ultrahigh-pressure pump, or a hydraulic pressure intensifier.

3. The solid animal waste disintegration roamer of claim 1, further comprising a second fluid reservoir disposed within the body and fluidly coupled to the at least one nozzle.

4. The solid animal waste disintegration roamer of claim 3, wherein the second fluid reservoir is configured to store at least one of a fragrance or an additive to assist in disintegration of solid animal waste.

5. The solid animal waste disintegration roamer of claim 1, wherein at least one camera is positioned on an underside of the body.

6. The solid animal waste disintegration roamer of claim 1, further comprising a top cover disposed over the body and enclosing the cavity, the top cover including a control panel in electronic communication with the controller.

7. The solid animal waste disintegration roamer of claim 6, wherein the control panel includes at least one indicator corresponding to at least one of a water level, a fragrance level, or a battery level.

8. The solid animal waste disintegration roamer of claim 1, wherein the controller further comprises a wireless transceiver configured to communicate with at least one external communications device.

9. The solid animal waste disintegration roamer of claim 8, further comprising instructions to receive, via the wireless transceiver, a cleaning program corresponding to a predetermined disintegration operation.

10. The solid animal waste disintegration roamer of claim 9, wherein the controller further comprises a navigation component configured to receive analyzed image data and direct movement of the roamer in accordance therewith.

11. The solid animal waste disintegration roamer of claim 1, further comprising a charging port positioned on an external side of the body, the charging port electrically coupled to the power supply and configured to receive power via an external source.

12. The solid animal waste disintegration roamer of claim 1, further comprising a water inlet positioned on an external side of the body, the water inlet fluidly coupled to the first fluid reservoir and configured to receive a first fluid therethrough.

13. The solid animal waste disintegration roamer of claim 1, wherein the pump is configured to expel fluid in the range of 800 to 1500 PSI.

14. The solid animal waste disintegration roamer of claim 1, wherein the pump is configured to expel fluid with a flow rate of 0.05 to 0.15 GPM.

15. A solid animal waste disintegration roamer, comprising:
a body, including:
a water reservoir disposed within the body and coupled to a water inlet passing through to an exterior surface of the body,
a pump fluidly coupled to the reservoir within the body, and
at least one camera disposed on an exterior surface of the body;
a retractable nozzle cone disposed on a bottom surface of the body, the nozzle cone configured to extend downward and retract upward in accordance with a disintegration operation;
at least one nozzle positioned on the bottom surface of the body, the at least one nozzle disposed within the nozzle cone and in fluid communication with the pump, wherein the at least one nozzle is configured to expel at least one of a high-pressure or a low-pressure fluid; and
a controller comprising a processor in communication with memory storing instructions which are executed by the processor to:
analyze image data captured by the at least one camera to identify solid animal waste,
direct movement of the roamer in accordance with the analyzed image data,
extend the retractable nozzle cone downward over the identified solid animal waste, and
activate the pump to expel at least one of the high-pressure fluid or the low-pressure fluid through the at least one nozzle to disintegrate the identified solid animal waste.

16. The solid animal waste disintegration roamer of claim 15, wherein the pump comprises at least one of a linear intensifier pump, a high-pressure water jet pump, a hyper-jet ultrahigh-pressure pump, or a hydraulic pressure intensifier.

17. The solid animal waste disintegration roamer of claim 16, further comprising:
rechargeable power supply disposed within the body and electrically coupled to the pump and the controller; and
a charging port positioned on an external side of the body, the charging port electrically coupled to the power supply and configured to receive power via an external source.

18. A solid animal waste disintegration system, comprising:
a roamer component comprising:
a body, including:
a water reservoir disposed within the body and coupled to a water inlet passing through to an exterior surface of the body,
a pump fluidly coupled to the reservoir within the body,
a controller communicatively coupled to the pump,
a power supply electrically coupled to the pump and the controller,
a charging port positioned on an external side of the body, the charging port electrically coupled to the power supply and configured to receive power via an external source, and
at least one camera disposed on an exterior surface of the body, the camera in data communication with the controller,
a retractable nozzle cone disposed on a bottom surface of the body, the nozzle cone configured to extend downward and retract upward in accordance with a disintegration operation, and
at least one nozzle positioned on the bottom surface of the body, the at least one nozzle disposed within the nozzle cone and in fluid communication with the pump, wherein the at least one nozzle is configured to expel at least one of a high-pressure or a low-pressure fluid; and
a charging pad component, the charging pad component including:
a base portion,
a resupply tank positioned at one end of the base portion, the resupply tank including a charging connection configured to engage the charging port of the roamer, and,
a water outlet configured to engage the water inlet of the roamer.

19. The solid animal waste disintegration system of claim 18, wherein the resupply tank of the charging pad component further comprises a resupply inlet configured to receive a replenishment fluid therethrough.

20. The solid animal waste disintegration system of claim 19, wherein the charging pad component further comprises an electrical connection coupled to the charging connection and configured to receive a connection of an external power supply.

21. A hand-held solid-animal waste disintegration apparatus, comprising:
a body having a first end and a second end, including:
a first fluid reservoir disposed within the body proximal to the first end,
a pump fluidly coupled to the reservoir within the body and positioned between the first fluid reservoir and the second end,
a power supply electrically coupled to the pump positioned within the body;
an extension tube fluidly coupled to the pump at a first end and configured to extend and retract into the body relative to the second end;
a retractable nozzle cone disposed on a second end of the extension tube, the nozzle cone configured to extend downward and retract upward; and
at least one nozzle positioned on the second end of the extension tube, the at least one nozzle disposed within the nozzle cone and in fluid communication with the pump, wherein the at least one nozzle is configured to expel at least one of a high-pressure or a low-pressure fluid.
